(19) United States
(12) Patent Application Publication
(10) Pub. No.: US 2017/0026431 A1
(43) Pub. Date: Jan. 26, 2017

(54) MULTICAST MECHANISM FOR WIRELESS DEVICES

(71) Applicant: Intel IP Corporation, Santa Clara, CA (US)

(72) Inventors: Elad Oren, Tel Aviv (IL); Po-Kai Huang, Santa Clara, CA (US); Robert Stacey, Portland, OR (US); Dibakar Das, Hilsboro, OR (US); Emily Qi, Camas, WA (US); Minyoung Park, Portland, OR (US)

(21) Appl. No.: 14/978,205

(22) Filed: Dec. 22, 2015

Related U.S. Application Data
(60) Provisional application No. 62/194,499, filed on Jul. 20, 2015.

(51) Int. Cl. H04L 29/06; H04W 72/04

(52) U.S. Cl. CPC H04L 65/4076; H04W 72/0413

(57) ABSTRACT

This disclosure describes methods, apparatus, and systems related to a multicast mechanism. A device may determine a multicast session with one or more multicast devices. The device may determine one or more multicast data frames. The device may determine a conditional block acknowledgment request associated with the one or more multicast data frames. The device may cause to send the one or more data frames to at least one of the one or more multicast devices. The device may cause to send the conditional block acknowledgment request to the one or more multicast devices.

### CROSS-REFERENCE TO RELATED APPLICATIONS

This application claims the benefit of U.S. Provisional Application No. 62/194,499 filed Jul. 20, 2015 the disclosure of which is incorporated herein by reference as if set forth in full.

### TECHNICAL FIELD

This disclosure generally relates to systems and methods for wireless communications and, more particularly, to a multicast mechanism for wireless devices in wireless communications.

### BACKGROUND

Wireless devices are becoming widely prevalent, making them suited for location-based services. Wireless devices may benefit from location-based services that may result in an enhanced user experience. Recently, there has been a shift in technology to support direct wireless communications, including one-to-many or many-to-many messaging, such as multicasting, between wireless devices

### BRIEF DESCRIPTION OF THE DRAWINGS

FIG. 1 depicts a network diagram illustrating an example network environment of an illustrative multicast system, according to one or more example embodiments of the disclosure.

FIG. 2 depicts an illustrative schematic diagram of a multicast system, in accordance with one or more example embodiments of the present disclosure.

FIG. 3 depicts a flow diagram of an illustrative process for an illustrative multicast system, in accordance with one or more embodiments of the disclosure.

FIG. 4 depicts a flow diagram of an illustrative process for an illustrative multicast system, in accordance with one or more embodiments of the disclosure.

FIG. 5 illustrates a functional diagram of an example communication station that may be suitable for use as a user device, in accordance with one or more example embodiments of the disclosure.

FIG. 6 is a block diagram of an example machine upon which any of one or more techniques (e.g., methods) may be performed, in accordance with one or more embodiments of the disclosure.

### DETAILED DESCRIPTION

Example embodiments described herein provide certain systems, methods, and devices, for providing signaling information to Wi-Fi devices in various Wi-Fi networks.

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

In communications, multicast (one-to-many or many-to-many distribution) is a communication involving multiple devices, where data frames are transmitted simultaneously to selected devices involved in a multicast group. In many-to-many multicast transmissions, multicast transmissions need to be efficient, that is, they should have low overhead and high probability of successful transmission. Wi-Fi devices involved in the many-to-many multicast transmissions may require confirmation or acknowledgment, whether a transmitted data packet has been received by another device. Wi-Fi devices following one or more Wi-Fi standards (e.g., Wi-Fi aware, Wi-Fi infrastructure, Wi-Fi direct, or the like) may implement mechanisms to allow for multicast transmissions. For example, Wi-Fi Aware 2.0 (so referred to as NAN2) devices can transmit data to each other without any infrastructure (e.g., AP). In particular, after the discovery process, Wi-Fi Aware 2.0 devices that can transmit to each other may form a group. This group of devices may meet on fixed time periods and channels, referred to as “timeblocks”, to communicate with each other. Announcement of such timeblocks may be made by a device in the group during the discovery window. It is understood that the Wi-Fi Aware 2.0 is only an example of how a many-to-many multicast transmission may occur and that other Wi-Fi standards may implement multicast transmissions differently.

Example embodiments of the present disclosure relate to systems, methods, and devices for a multicast mechanism that implement a data frame transmission strategy, and a Modulation and Coding Scheme (MCS) selection strategy to minimize control packet overhead.

Typically, GroupCast with Retries BlockAck (GCR-BA) algorithm implemented by the Institute of Electrical and Electronics Engineers (IEEE) 802.11aa may be used in multicast systems. Under the GCR-BA algorithm, the multicast transmitting device polls each device receiving the data frames for an acknowledgment (e.g., BlockACK) after transmitting a burst of data frames. However, this mechanism may have unnecessarily large overhead under good network conditions.

In one embodiment, a multicast mechanism may be implemented between one or more devices belonging to a multicast group. A multicast group may include devices that may communicate with each other using many-to-many communication or one-to-many communications. The multicast mechanism may facilitate sending and receiving data between the one or more devices, such that, when a transmitting device multicasts a burst of data frames to multiple devices within the multicast group, the transmitting device may receive feedback from these multiple devices under predetermined conditions. The predetermined conditions may include determining whether data frames were not successfully received by the receiving device. In scenarios where favorable network conditions are present, for example, between devices in close proximity to each other, implementing the multicast mechanism may result in a lower overhead in the multicast transmissions. This is because it may not be necessary for each data frame to be confirmed by the receiving device. That is, the receiving device does not respond to each data frame received from the transmitting device. In another embodiment, the multicast mechanism may determine an MCS value that may be selected based on feedback collected periodically from one or more receiving devices. In Wi-Fi Wireless local area networks, such as those following IEEE 802.11 standards, a receiver is required to suggest transmitter modulation and coding schemes (MCS) based on transmission environment, and the MCS adopted by the transmitter is selected according to variations in the transmission environment so as to maintain optimal transmission throughput.

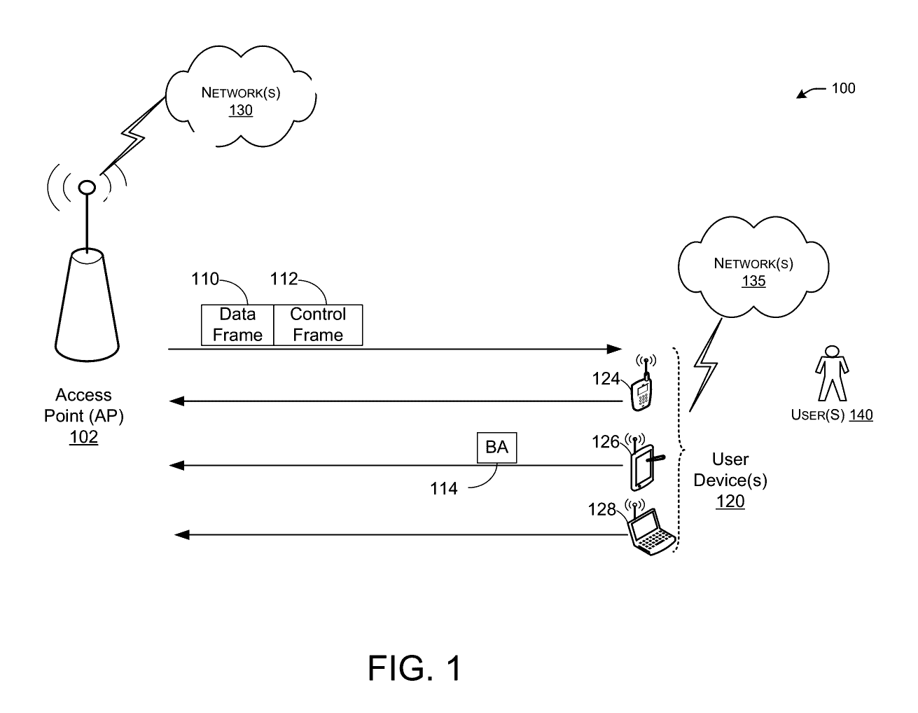

FIG. 1 is a network diagram illustrating an example wireless network 100 of a multicast system, according to some example embodiments of the present disclosure. Wireless network 100 can include one or more user devices 120 (e.g., 122, 124, 126, or 128), which may communicate in accordance with wireless standards, such as the IEEE 802.11 communication standards. For example, two or more wireless devices may perform connectivity procedures with one another in order to set up Wi-Fi data sessions, according to some example embodiments of the present disclosure. In the example of FIG. 1, a wireless communication channel may be established between two or more wireless devices (e.g., user device(s) 120). The user device(s) 120 may be wireless devices that are non-stationary and do not have fixed locations.

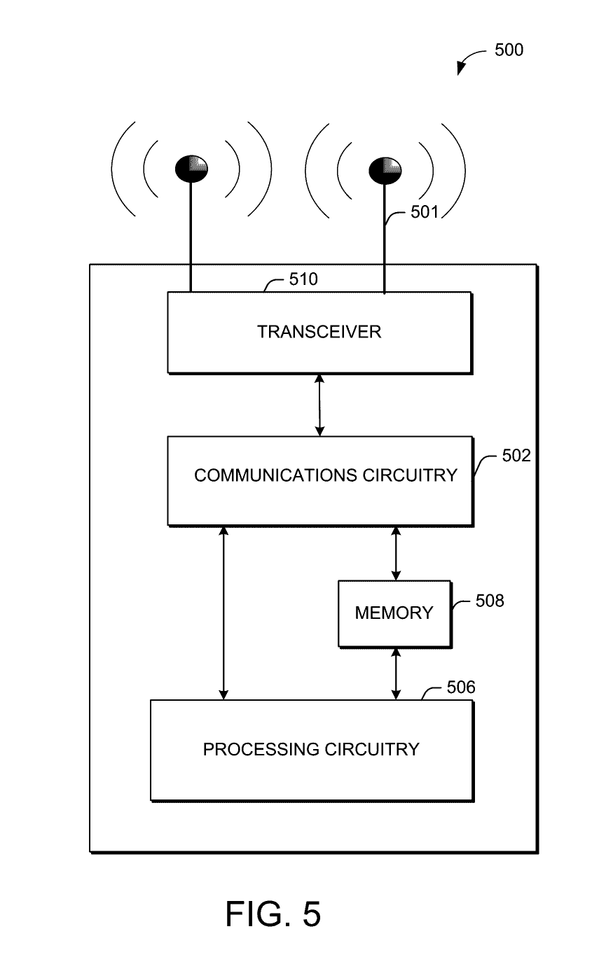

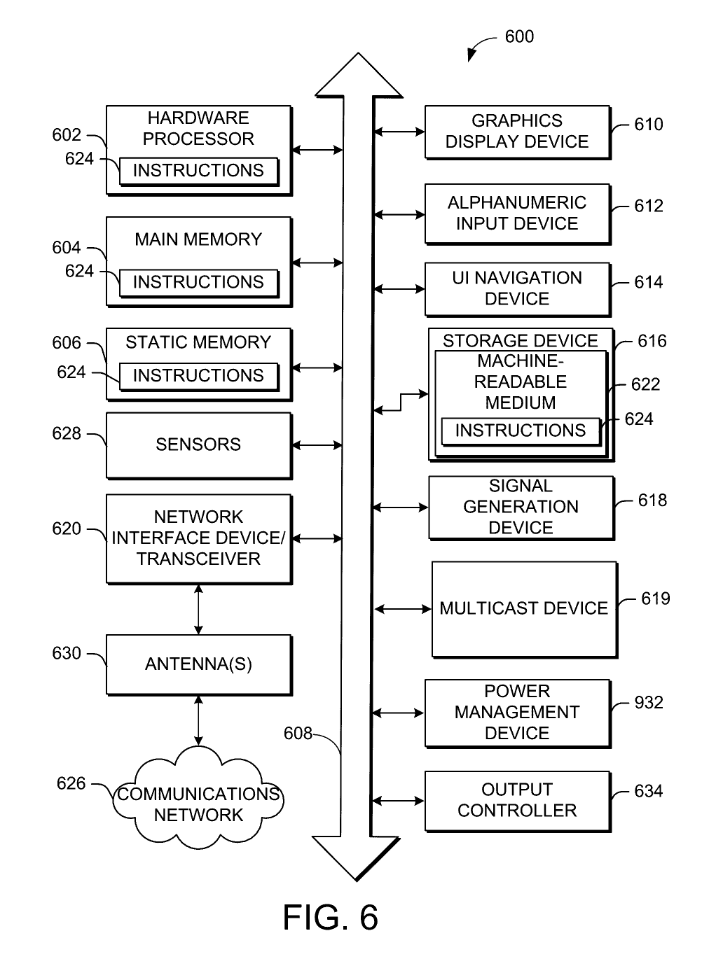

In some embodiments, the user devices 120 may include one or more computer systems similar to that of the functional diagram of FIG. 5 and/or the example machine/system of FIG. 6.

One or more illustrative user device(s) 120 may be operable by one or more user(s) 140. The user device(s) 120 (e.g., 124, 126, or 128) may include any suitable processor-driven user device including, but not limited to, a desktop user device, a laptop user device, a server, a router, a switch, an access point, a smartphone, a tablet, wearable wireless device (e.g., bracelet, watch, glasses, ring, etc.) and so forth.

Any of the user device(s) 120 (e.g., user devices 124, 126, 128), and AP 102 may be configured to communicate with each other via one or more Communications network 130 wirelessly or wired. Communications network 130 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, communications network 130 may have any suitable communication range associated therewith and may include, for example, global networks (e.g., the Internet), metropolitan area networks (MANs), wide area networks (WANs), local area networks (LANs), or personal area networks (PANs). In addition, communications network 130 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the user device(s) 120 (e.g., user devices 124, 126, 128), and AP 102 may include one or more communications antennae. Communications antenna may be any suitable type of antenna corresponding to the communications protocols used by the user device(s) 120 (e.g., user devices 124, 124 and 128), and AP 102. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, or the like. The communications antenna may be communicatively coupled to a radio component to transmit and/or receive signals, such as communications signals to and/or from the user devices 120.

Any of the user devices 120 (e.g., user devices 124, 126, 128), and AP 102 may include any suitable radio and/or transceiver for transmitting and/or receiving radio frequency (RF) signals in the bandwidth and/or channels corresponding to the communications protocols utilized by any of the user device(s) 120 and AP 102 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g. 802.11b, 802.11g, 802.11n), 5 GHz channels (e.g. 802.11n, 802.11ac), or 60 GHZ channels (e.g. 802.11ad). In some embodiments, non-Wi-Fi protocols may be used for communications between devices, such as Bluetooth, dedicated short-range communication (DSRC), Ultra-High Frequency (UHF) (e.g. IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

Systems and methods in accordance with various embodiments of the present disclosure provide a multicast mechanism between one or more devices (e.g., user device(s) 120 and/or AP 102) belonging to a multicast group. In the multicast group, AP 102 may send data frame 110, using a multicast transmission to three user devices 120 (e.g., user devices 124, 126 and 128). The data frame 110 may be received either successfully or unsuccessfully by user devices 124, 126 and 128). AP 102 may send a control frame 112 to user devices 124 126 and 128. The control frame 112 may be a conditional multicast block acknowledgment request, such that one or more conditions may be implemented by the receiving devices upon receiving the control frame 112.

The multicast mechanism may include a data frame transmission policy and MCS selection policy for which receiving devices may receive the data frames with low control packet overhead. In one aspect, the data frame transmission policy may involve determining whether an acknowledgment is required based on network conditions. After sending the control frame 112, the transmitting device (e.g., AP 102) may wait for a window of time before deducing that the data frame has been received by user devices 124, 126 and 128. If AP 102 does not receive an acknowledgment from user devices 124, 126, or 128, the multicast mechanism may determine that the data frame 110 was successfully received by the three user devices. In that sense, the receiving devices (e.g., user devices 124, 126 and 128) send feedback only if they do not successfully receive the data frame. Further, there is no need for the transmitting device to solicit block acknowledgments from every receiving device upon sending the data frame 110. As a result, transmission overhead may be reduced due to reduced messaging between the transmitting device and the receiving devices. For example, assuming that the data frame 110 was not successfully received by user device 126; user device 126 may send a block acknowledgment (e.g., BA 114) to AP 102. BA 114 may acknowledge or inform AP 102 that data frame 110 is not successfully received by user device 126.

In another aspect, the MCS selection policy may involve determining an appropriate MCS value for data frames transmissions based on network conditions. Both of these mechanisms may also depend on a buffer size of the receiving device. For example, a transmitting device (e.g., user device 124) and a receiving device (e.g., user device 126) may exchange capability information such that the transmitting device may know the buffer size of the receiving device. The buffer size may determine how many data frames may be maintained or buffered during data frame transmissions at the receiving device. For example, if a data frame was not successfully received by the receiving device, the receiving device may hold in its buffer other data frames until the receiving device successfully receives the failed data frame. Therefore, based on the buffer size, a transmitting device may employ the multicast mechanism or fallback to a previous mechanism (e.g., GCR-BA).

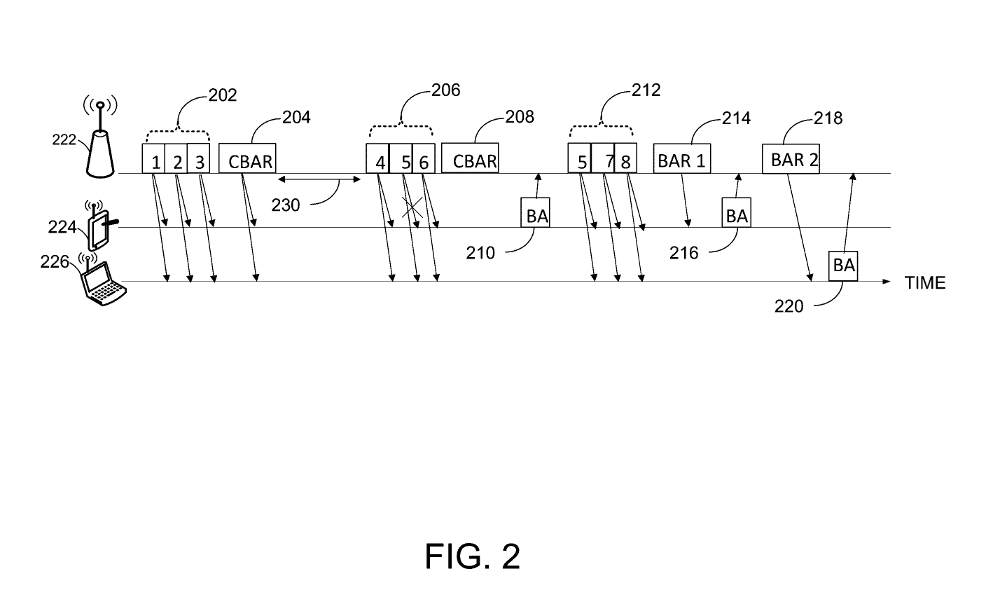

FIG. 2 depicts an illustrative schematic diagram of a multicast mechanism, in accordance with one or more example embodiments of the present disclosure.

In one embodiment, a multicast system may allow a transmitting device (e.g., user device(s) 120) to either solicit regular feedback or conditional feedback from the receiving devices (e.g., user device(s) 120) based on one or more conditions after (or before) sending a burst of data frames. In the example of FIG. 2, an AP 222 may send one or more bursts of data frames (e.g., bursts 202, 206, 212). In this example, after transmitting a burst of data frames (e.g., data frames 1, 2, and 3), the multicast transmitting device (e.g., AP 222) may solicit conditional feedback frames from multicast receiving devices (e.g., user devices 224 and 226) until a timer expires. The conditional feedback frames may involve sending a control frame (e.g., CBAR frame 204) to the multicast group members (e.g., user devices 224 and 226). If data frames 1, 2, and 3 were received successfully by the user devices 224 and 226, no block acknowledgment (BA) may be necessary. The AP 222 may wait for a period of time until a timer expires (e.g., timer 230) before continuing with the rest of the data frame bursts (e.g., bursts 206 and 212). In this example, after the first burst, the receiving devices 224 and 226 did not send a feedback frame before the expiration of timer 230. Therefore, AP 222 determines that the data frames 1, 2, and 3 of burst 202 were successfully received by the multicast group members (e.g., user devices 224 and 226). If, however, one of the data frames and another burst (e.g., burst 206) was not successfully received by at least one of the multicast group members, the device that did not receive the data frame may send feedback to the AP 222, indicating that a data frame was not successfully received. For example, if user device 224 did not receive data frame 5, user device 224 may send feedback frame BA 210 to AP 222. AP 222 may determine that data frame 5, in burst 206, was not successfully received by user device 224. In that case, AP 222 may re-transmit the missing data frame (e.g., data frame 5) in the next burst.

In one embodiment, after a predetermined number of unsuccessful data frame transmissions or receptions, the transmitting device may revert back to soliciting feedback from all receiving devices instead of soliciting conditional feedbacks. This may be done based on a determination that the failure of the data frames may be due to unfavorable network conditions, which may result in other data frames failures. By soliciting feedback from all receiving devices, the overhead may be increased, but the reliability of the system may also be enhanced. After a predetermined time of soliciting feedback from all receiving devices, the transmitting device may revert back to soliciting conditional feedback if the transmitting device determines that the network conditions have improved or the number of failed multicast data frames is below a certain threshold.

In one embodiment, the transmitting device (e.g., AP 222) may send a burst of multicast data frames (e.g., bursts 202, 206, 212) addressed to the multicast group (e.g., user device 224 and user device 226). The number of frames in the burst may be fixed to some number N_win and may be set based on a receiving device buffer size and the selected Modulation and Coding Scheme (MCS). The numbers of frames in the burst may be less than N_win if there are not enough frames to be sent to the multicast group. For example, the larger the buffer size of the receiving device, the greater the number of data frames within each burst. The number of data frames is correlated to the buffer size because based on the buffer size, the receiving device may hold the number of data frames in its buffer until any failed data frames are retransmitted by the transmitting device and received by the receiving devices. For example, in the case where data frame 5 of FIG. 2 was not successfully received by user device 224, user device 224 may hold in its buffer the successfully received data frames 4 and 6 until data frame 5 is retransmitted by AP 222 in burst 212 and correctly received. User device 224 may then be able to process data frames 4, 5, and 6 in sequence as was intended by AP 222 when it transmitted burst 206.

Under some condition, for example, if the transmitting device did not receive conditional feedback frames (e.g., conditional feedback frame 204 and 208) or feedback frames (e.g., feedback frames 210, 216, and 220) from every receiving device after transmission of previous data burst, the transmitting device may send a unique short control frame (e.g., CBAR frame 204 or 208) along with the next data burst soliciting conditional feedback frames (e.g., conditional feedback frame 210). The transmitting device (e.g., user device(s) 120) may solicit regular explicit feedback from all or a subset of receiving devices if that condition is not satisfied. The control frame may be sent before or after the associated data burst(s). For example, CBAR 204 may be sent to the devices of the multicast group (e.g., user devices 224 and 226) before sending burst 202 or may be sent after sending burst 202. The control frame may be formatted similar to the IEEE 802.11aa BlockAck Request frame. In some embodiments, the control frame may contain a start sequence number (SSN). The SSN may be associated with the data frames being sent to the receiving devices. The SSN may be initialized to zero. The SSN may maintain sequence numbers of data frames that may be shared with the receiving devices. For example, the SSN may indicate the sequence number of the oldest frame whose lifetime has not yet expired. This may inform the receiving device of any outstanding frames that have not been yet confirmed.

In some embodiments, the control frame may contain a bitmap of transmitted data frames. The control frame may contain an element representing the sequence number of frames in the associated data burst(s). This may be indicated by including the sequence number of the first frame in the burst and the number of data frames in the burst(s), or including the sequence number of the first frame in the burst(s) and the sequence number of the last frame in the burst(s), or including the list (or bitmap) of sequence number of frames in the data burst(s), or some other element indicating number (and/or sequence number) of frames in the burst.

In one embodiment, the transmitting device (e.g., AP 222) may retransmit data frames to those receiving devices which have indicated that they did not receive certain data frames correctly. For example, AP 22 may send these data frames that were not received correctly, through either multicast or unicast. For example, AP 222 may determine that three data frames were not received by user devices 224 and 226 and may retransmit these data frames simultaneously to user devices 224 and 226 in a multicast fashion or may send each data frame directly to the corresponding device.

In one embodiment, a retry bit may be included in the data frames to indicate whether a given data frame was retransmitted or not. After retransmitting data frames, the transmitting device may solicit explicit acknowledgments (for example, by transmitting a BlockAck Request) from all receiving devices or those receiving devices that indicated they were unsuccessful in receiving a data frame. The transmitting device (e.g., AP 222) may keep retransmitting missing frames until those receiving devices (e.g., user devices 224 or 226) either receive the data frame or a maximum retry limit for that frame is reached based on the retry bit value.

In one embodiment, a receiving device (e.g., user devices 224 and 226) may send feedback whenever it is polled or when it realizes it did not some data frames or under some other condition(s). The receiving device may decide whether or not it has received all data frames correctly based on the contents of its reorder buffer as well as the short control frames received from the transmitting device. Each receiving device may maintain a reorder buffer containing all frames, which are waiting to be sent to the upper layers if a data frame with lower sequence number has not been received yet. On receiving a data frame, a receiving device may compare its sequence number against that of the missing data frame with largest sequence number. If all data frames prior to this particular data frame have been received, then the frame may be sent to the upper layers. In addition, all data frames with sequence number higher than the received frame and lower than that of the next missing frame may be sent to the upper layer. A receiving device may deduce a frame with sequence number N to be missing if it received frames with sequence number N−1 mod M and N+1 mod M but not N mod M, where M denotes the maximum possible sequence number. Otherwise, the frame may be queued at the reorder buffer.

In some embodiment, a receiving device (e.g., user device 224 or 226) may transmit a feedback frame to the transmitting device, after receiving a short control frame (e.g., CBAR 204, or 208). If a receiving device has correctly received every data frame starting with the frame whose sequence number equals SSN in the received control frame, until the received data frame with highest sequence number, then it may not transmit the feedback frame. Otherwise, a receiving device may transmit a feedback frame to the transmitting device if one or more data frames were determined to have been unsuccessfully received.

The structure of the feedback frame may be either the same or similar to that of the BlockAck frames in IEEE 802.11. In some examples, it may be a bitmap representing received data frames. In the feedback frame, the receiving device may acknowledge the frames with sequence number starting from the SSN until the data frame with the highest sequence number that has been received in some instances, the bit positions corresponding to other data frames may be set to zero. The feedback frame may only represent, using a bitmap, the data frames starting from the oldest missing frame until the data frame with the highest sequence number that has been received. Bits representing received frames may be set to 1; others may be set to zero. In addition, the feedback frame may include an element listing the sequence number of the oldest missing frame at the receiving device. A receiving device may use carrier sense multiple access (CSMA) backoff prior to transmitting feedback frames so as to avoid collisions among multiple conditional feedback frames. It is understood that CSMA is a probabilistic media access control (MAC) protocol in which a node verifies the absence of other traffic before transmitting on a shared transmission medium or a band of the electromagnetic spectrum. The transmitting device may specify, in the short control frames, a set of receiving devices that may send a conditional feedback frame following the data burst. A receiving device may also transmit conditional feedback frames on their own if the number of frames in the reorder buffer is above some threshold. A receiving device may transmit feedback frames on receiving explicit feedback request frame (e.g., feedback request frames 214 and 218) from the transmitting device. The structure of the feedback frame may be similar to that of the conditional feedback frames.

In one embodiment, for many-to-many multicast scenario, user devices 120 participating in a multicast group may be awoken simultaneously. As a result, multicast receiving devices may transmit feedback to different transmitting devices on receiving a conditional feedback request from one transmitting device. For example, suppose multicast receiving device A receives conditional feedback request from transmitting device B followed, after sometime, by transmitting device C. If A could not send a feedback frame to B before B's timer expired, then on receiving a conditional feedback request from C, A may transmit feedback to both B and C. A may multicast an aggregate feedback frame to both B and C. A may transmit a feedback frame to B followed by that to C, or vice versa. It is understood that above is only an example and that other example many-to-many multicast scenarios may be implemented.

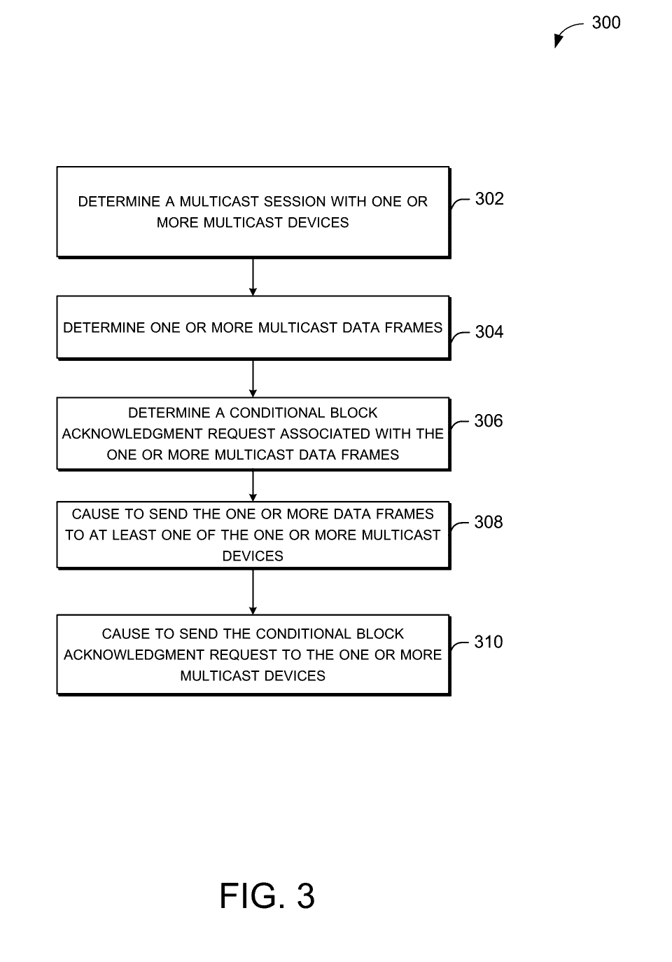

FIG. 3 illustrates a flow diagram of illustrative process 300 for a multicast system, in accordance with one or more embodiments of the disclosure.

At block 302, a transmitting device (e.g., user device 120 and/or AP 102 of FIG. 1) may determine a multicast session with one or more multicast devices. The multicast session involves transmitting data frames simultaneously to one or more multicast devices in a multicast group. A device wishing to transmit a multicast communication to the other multicast devices in the multicast group may establish a multicast session such that the transmitting device is capable of sending the data frames to the one or more multicast devices in the multicast group.

At block 304, the transmitting device may determine one or more multicast data frames. The transmitting device may generate one or more multicast data frames that may be sent to the one or more multicast devices. The data frames may be associated with data bursts that are sent in the time domain to the one or more multicast devices. For example, a data burst may include one or more multicast data frames sent to the one or more multicast devices. The one or more multicast devices may receive the one or more multicast data frames associated with the data burst. In some scenarios, one or more of these multicast data frames may not be successfully received by some of the multicast devices. In some scenarios, a transmitting device may exchange one or more capability information with one or more receiving devices. For example, during connection setup, one or more multicast devices may exchange capability information so that a transmitting device may determine the buffer size of the receiving device (the number of frames available at the receiving device for reordering). The transmitting device may use this information to determine the size of the data burst. One or more user devices 120 involved in the multicast session may wake up in each timeblock negotiated during the connection setup.

At block 306, the transmitting device may determine a conditional block acknowledgment request (CBAR) associated with the one or more multicast data frames. The CBAR may include information related to multicast data frames that are sent to the one or more multicast devices.

At block 308, the transmitting device may send the one or more data frames to at least one of the one or more multicast devices. In some embodiments, the device may send a non-conditional block acknowledgment request (BAR), which follows the GroupCast with Retries BlockAck (GCR-BA) algorithm implemented by the Institute of Electrical and Electronics Engineers (IEEE) 802.11aa. The BAR may be send based on determining the network conditions during the multicast session. For example, the transmitting device may transmit using either GCR-BA or using the CBAR, based at least in part on whether the probability of successful reception of data frames at the multicast receiving devices is high or not. For example, the transmitting device may select the GCR-BA scheme in case of high errors and may select sending CBAR in case of low errors. The multicast transmitting device (e.g., user device(s) 120) may obtain this information by collecting feedback from the receiving devices (e.g., user device(s) 120).

At block 310, the transmitting device may cause to send the CBAR to the one or more multicast devices. After the transmitting device sends the CBAR, the transmitting device may determine a time window associated with the CBAR. The transmitting device may wait to receiving any feedback from the receiving devices based on the multicast data frames that were sent to them. After the passage of the time window, the transmitting device may determine that all the multicast data frames were successfully received by the receiving devices in the multicast session. However, if one of the receiving devices did not successfully receive one of the multicast data frames, the transmitting device may expect a feedback from this receiving device. The feedback may be in the form of a block acknowledgement (BA) frame that is sent from the receiving device to the transmitting device in case one or more multicast data frames were not successfully received by the receiving device. The BA may include information associated with which multicast data frame(s) were not received by the receiving device. Upon receiving the BA, the transmitting device may at least one of the one or more multicast data frames was not successfully received by the at least one of the one or more multicast devices in the multicast session. In that case, the transmitting device may resend the at least one of the one or more multicast data frames the at least one of the one or more multicast devices based at least in part on the block acknowledgment.

In some embodiment, a transmitting device may select a new Modulation and Coding Scheme (MCS) based on estimate of the data frame error rate using a current MCS. This estimate may be obtained indirectly by observing feedbacks collected over a period from the receiving devices (e.g., BAs). This estimate may also be obtained directly by requesting the receiving devices periodically for performance parameters (e.g., packet error rate, Signal to Noise Ratio). If the error rate is higher than some threshold, the transmitting device may use a lower MCS than the current and vice versa.

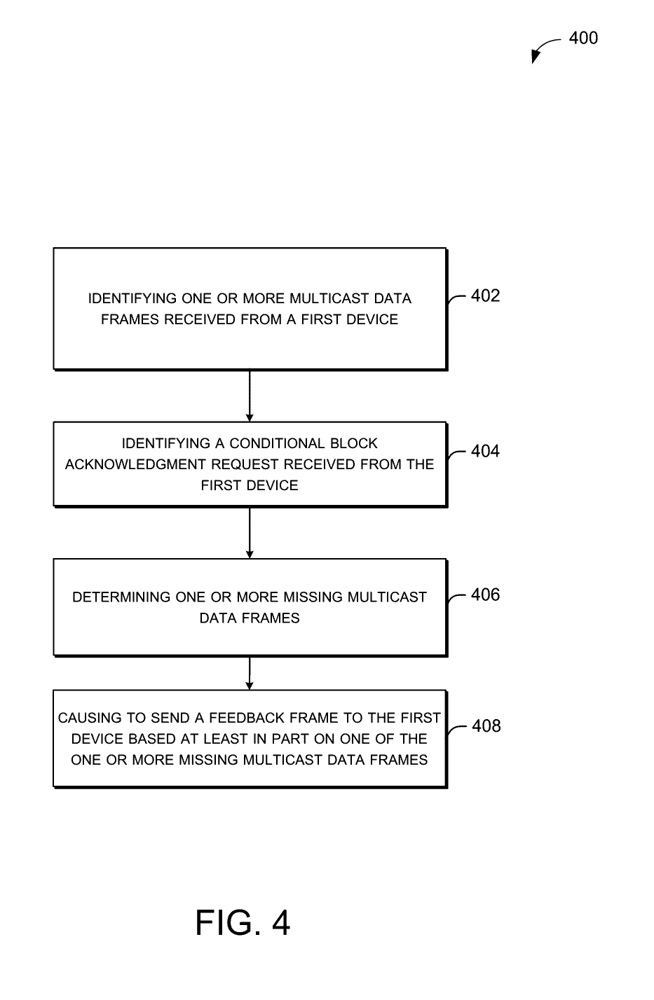

FIG. 4 illustrates a flow diagram of illustrative process 400 for a multicast system, in accordance with one or more embodiments of the disclosure.

At block 402, a receiving device (e.g., user device 120 and/or AP 102 of FIG. 1) involved in a multicast session with a transmitting device (e.g., user device 120 and/or AP 102 of FIG. 1) may identify one or more multicast data frames received from the transmitting device. The multicast session involves transmitting data frames simultaneously to one or more multicast devices in a multicast group, including the receiving device. In some scenarios, the receiving device may share its capability information, including a buffer size that may be used for buffer data, including but not limited to multicast data frames received from the transmitting device.

At block 404, the receiving device may identify a conditional block acknowledgment request (CBAR) associated with the one or more multicast data frames. The CBAR may include information related to multicast data frames that are sent to the one or more multicast devices. In some embodiments, the receiving device may receive a non-conditional block acknowledgment request (BAR) from the transmitting device. The BAR follows the GroupCast with Retries BlockAck (GCR-BA) algorithm implemented by the Institute of Electrical and Electronics Engineers (IEEE) 802.11aa. Receiving CBAR and/or BAR may be based on the network conditions during the multicast session. In some embodiments, the transmitting device may determine which mechanism to use (CBAR or BAR) based on whether multicast data frames are being received successfully by the receiving device.

At block 406, the receiving device may determine one or more missing multicast data frames. For example, after the transmitting device sent one or more multicast data for to the multicast group, including the receiving device, the receiving device may determine whether some of these multicast data frames were missing based at least in part on the CBAR. The CBAR may be a control frame, which may contain, at least in part, information related to the one or more multicast data frames that were sent by the transmitting device. For example, the CBAR may contain a start sequence number (SSN), that may be initialized to zero and that maintains sequence numbers of data frames that are being shared with the receiving devices in the multicast session. It is understood that the above CBAR format is only an example and that other format of CBAR may also be employed. Based on the information contained in the CBAR, the receiving device may determine whether it is missing some multicast data frames.

At block 408, the receiving device may causing to send a feedback frame to the transmitting device based at least in part on one of the one or more missing multicast data frames. As the receiving device determines whether some of the multicast data frames are missing based on the received CBAR, the receiving device may generate a feedback frame in order to notify the transmitting device. The feedback frame may be a block acknowledgment (BA) that may include at least in part information of the missing multicast data frames. The receiving device may send the feedback before the expiry of a predetermined period that may be determined by the transmitting device. The predetermined time window may be associated with the conditional block acknowledgment request. That is, the transmitting device may start a timer. After sending the CBAR to the one or more receiving devices in the multicast session, the predetermined window may be set such that after the expiry of the timer, the transmitting device may assume that the multicast data frames have been received by the receiving devices in the multicast session. However, if the receiving device sends the BA to the transmitting device within the predetermined window, the transmitting device may determine that the missing multicast data frames may need to be resent to the receiving device. In the meantime, the receiving device may maintain the previously received multicast data frames in its buffer until the receiving device receives the missing multicast data frames. When the receiving device receives the new submission of the previously missed multicast data frames, the receiving device may place the missing multicast data frames in sequence with the previously received multicast data frames and then processed data. It is understood that the above is only an example of how a receiving device may handle receiving the previously missed multicast data frames and that other mechanism may be employed, such that the receiving device may utilize the retransmitted multicast data frames. In addition to the previously received multicast data frames.

FIG. 5 shows a functional diagram of an exemplary communication station 500 in accordance with some embodiments. In one embodiment, FIG. 5 illustrates a functional block diagram of a communication station that may be suitable for use as an AP 102 (FIG. 1) or user device 120 (FIG. 1) in accordance with some embodiments. The communication station 500 may also be suitable for use as a handheld device, mobile device, cellular telephone, smartphone, tablet, netbook, wireless terminal, laptop computer, wearable computer device, femtocell, High Data Rate (HDR) subscriber station, access point, access terminal, or other personal communication system (PCS) device.

The communication station 500 may include communications circuitry 502 and a transceiver 510 for transmitting and receiving signals to and from other communication stations using one or more antennas 501. The communications circuitry 502 may include circuitry that can operate the physical layer communications and/or medium access control (MAC) communications for controlling access to the wireless medium, and/or any other communications layers for transmitting and receiving signals. The communication station 500 may also include processing circuitry 506 and memory 508 arranged to perform the operations described herein. In some embodiments, the communications circuitry 502 and the processing circuitry 506 may be configured to perform operations detailed in FIGS. 2-4.

In accordance with some embodiments, the communications circuitry 502 may be arranged to contend for a wireless medium and configure frames or packets for communicating over the wireless medium. The communications circuitry 502 may be arranged to transmit and receive signals. The communications circuitry 502 may also include circuitry for modulation/demodulation, upconversion/downconversion, filtering, amplification, etc. In some embodiments, the processing circuitry 506 of the communication station 500 may include one or more processors. In other embodiments, two or more antennas 501 may be coupled to the communications circuitry 502 arranged for sending and receiving signals. The memory 508 may store information for configuring the processing circuitry 506 to perform operations for configuring and transmitting message frames and performing the various operations described herein. The memory 508 may include any type of memory, including non-transitory memory, for storing information in a form readable by a machine (e.g., a computer). For example, the memory 508 may include a computer-readable storage device may, read-only memory (ROM), random-access memory (RAM), magnetic disk storage media, optical storage media, flash-memory devices and other storage devices and media.

In some embodiments, the communication station 500 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 500 may include one or more antennas 501. The antennas 501 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 500 may include one or more of a keyboard, a display, a non-volatile memory port, multiple antennas, a graphics processor, an application processor, speakers, and other mobile device elements. The display may be an LCD screen including a touch screen.

Although the communication station 500 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 500 may refer to one or more processes operating on one or more processing elements.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 500 may include one or more processors and may be configured with instructions stored on a computer-readable storage device memory.

FIG. 6 illustrates a block diagram of an example of a machine 600 or system upon which any one or more of the techniques (e.g., methodologies) discussed herein may be performed. In other embodiments, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a peer machine in peer-to-peer (P2P) (or other distributed) network environments. The machine 600 may be a personal computer (PC), a tablet PC, a set-top box (STB), a personal digital assistant (PDA), a mobile telephone, wearable computer device, a web appliance, a network router, switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 600 may include a hardware processor 602 (e.g., a central processing unit (CPU), a graphics processing unit (GPU), a hardware processor core, or any combination thereof), a main memory 604 and a static memory 606, some or all of which may communicate with each other via an interlink (e.g., bus) 608. The machine 600 may further include a power management device 632, a graphics display device 610, an alphanumeric input device 612 (e.g., a keyboard), and a user interface (UI) navigation device 614 (e.g., a mouse). In an example, the graphics display device 610, alphanumeric input device 612, and UI navigation device 614 may be a touch screen display. The machine 600 may additionally include a storage device (i.e., drive unit) 616, a signal generation device 618 (e.g., a speaker), a multicast device 619, a network interface device/transceiver 620 coupled to antenna(s) 630, and one or more sensors 628, such as a global positioning system (GPS) sensor, compass, accelerometer, or other sensor. The machine 600 may include an output controller 634, such as a serial (e.g., universal serial bus (USB), parallel, or other wired or wireless (e.g., infrared (IR), near field communication (NFC), etc.) connection to communicate with or control one or more peripheral devices (e.g., a printer, card reader, etc.)).

The storage device 616 may include a machine readable medium 622 on which is stored one or more sets of data structures or instructions 624 (e.g., software) embodying or utilized by any one or more of the techniques or functions described herein. The instructions 624 may also reside, completely or at least partially, within the main memory 604, within the static memory 606, or within the hardware processor 602 during execution thereof by the machine 600. In an example, one or any combination of the hardware processor 602, the main memory 604, the static memory 606, or the storage device 616 may constitute machine-readable media.

The multicast device 619 may be configured to allow a transmitting device to either solicit regular feedback or conditional feedback from the receiving devices based one or more conditions after sending a burst of data frames. For example, after transmitting a burst of data frames, the multicast transmitting device may solicit conditional feedback frames from multicast receiving devices until unfavorable network conditions or repeated errors occur during the transmission of multicast data frames. If at least one receiving device sends a feedback frame indicating that one or more of the expected multicast data frames are missing, the transmitting device may re-transmit the missing data frames in the next burst. In that case, the transmitting device may start soliciting feedback from the receiving devices in the multicast session instead of soliciting conditional feedbacks. The transmitting device may revert back to conditional feedback request when it determines that the network conditions are favorable or the number of failed multicast data frames is below a certain threshold.

While the machine-readable medium 622 is illustrated as a single medium, the term “machine-readable medium” may include a single medium or multiple media (e.g., a centralized or distributed database, and/or associated caches and servers) configured to store the one or more instructions 624.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 600 and that cause the machine 600 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., Electrically Programmable Read-Only Memory (EPROM), or Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 624 may further be transmitted or received over a communications network 626 using a transmission medium via the network interface device/transceiver 620 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), Plain Old Telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 620 may include one or more physical jacks (e.g., Ethernet, coaxial, or phone jacks) or one or more antennas to connect to the communications network 626. In an example, the network interface device/transceiver 620 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 600 and includes digital or analog communications signals or other intangible media to facilitate communication of such software. The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

The word “exemplary” is used herein to mean “serving as an example, instance, or illustration.” Any embodiment described herein as “exemplary” is not necessarily to be construed as preferred or advantageous over other embodiments. The terms “computing device”, “user device”, “communication station”, “station”, “handheld device”, “mobile device”, “wireless device” and “user equipment” (UE) as used herein refers to a wireless communication device such as a cellular telephone, smartphone, tablet, netbook, wireless terminal, laptop computer, a femtocell, High Data Rate (HDR) subscriber station, access point, printer, point of sale device, access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as ‘communicating’, when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

The term “access point” (AP) as used herein may be a fixed station. An access point may also be referred to as an access node, a base station, or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some embodiments may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some embodiments may be used in conjunction with one or more types of wireless communication signals and/or systems following one or more wireless communication protocols, for example, Radio Frequency (RF), Infra Red (IR), Frequency-Division Multiplexing (FDM), Orthogonal FDM (OFDM), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee, Ultra-Wideband (UWB), Global System for Mobile communication (GSM), 2G, 2.5G, 3G, 3.5G, 4G, Fifth Generation (5G) mobile networks, 3GPP, Long Term Evolution (LTE), LTE advanced, Enhanced Data rates for GSM Evolution (EDGE), or the like. Other embodiments may be used in various other devices, systems, and/or networks.

According to example embodiments of the disclosure, there may be a device. The device may include a least one memory that stores computer-executable instructions, and at least one processor configured to access the at least one memory, wherein the least one processor is configured to execute the computer-executable instructions to determine a multicast session with one or more multicast device; determine one or more multicast data frames; determine a conditional block acknowledgment request or a block acknowledgment request associated with the one or more multicast data frames; cause to send the one or more multicast data frames to at least one of the one or more multicast devices; and cause to send the conditional block acknowledgment request or the block acknowledgment request to the one or more multicast devices based at least in part on the sent one or more multicast data frames.

Implementation may include one or more of the following features. The device may identify a block acknowledgment from at least one of the one or more multicast devices. The device may identify capability information associated with at least one of the one or more multicast devices and may determine buffer size based at least in part on the capability information. The device may determine that at least one of the one or more multicast data frames was not successfully received by the at least one of the one or more multicast devices and resend the at least one or more multicast data frames to the at least one or more multicast device. The device may select a new Modulation and Coding Scheme (MCS) based at least in part on an estimate of data frame error rate using a current MCS. The device may further comprise a transceiver configured to transmit and receive wireless signals and may further comprise an antenna coupled to the transceiver.

According to example embodiments of the disclosure, there may be a non-transitory computer medium. The non-transitory computer-readable medium may store computer-executable instructions which, when executed by a processor, cause the processor to perform operations comprising identifying one or more multicast data frames received from a first device; identifying a conditional block acknowledgment request received from the first device; determining one or more missing multicast data frames; and causing to send a feedback frame to the first device based at least in part on one of the one or more missing multicast data frames.

Implementation may include one or more of the following features. The non-transitory computer-readable medium wherein the computer-executable instructions cause the processor to further perform operations may include operations causing to send the feedback frame within a predetermined time window. The predetermined time window may be associated with the conditional block acknowledgment request. Operations may include identifying one or more replacement multicast data frames associated with the missing multicast data frames. Operations may include determining capability information, including a buffer size associated with the one or more multicast data frames. The computer-executable instructions may cause the processor to further perform operations comprising causing to send the capability information to the first device.

According to example embodiments of the disclosure, there may be a method. The method may include operations comprising determining a multicast session with one or more multicast device; determining one or more multicast data frames; determining a conditional block acknowledgment request or a block acknowledgment request associated with the one or more multicast data frames; causing to send the one or more multicast data frames to at least one of the one or more multicast devices; and causing to send the conditional block acknowledgment request or the block acknowledgment request to the one or more multicast devices based at least in part on the sent one or more multicast data frames.

Implementation may include one or more of the following features. Operations comprising identifying a block acknowledgment from at least one of the one or more multicast devices may be included in the method. The method may include operations determining that at least one of the one or more multicast data frames was not successfully received by the at least one of the one or more multicast devices.

According to example embodiments of the disclosure, there may be an apparatus. The apparatus may include means for determining a multicast session with one or more multicast devices. The apparatus may include means for determining one or more multicast data frames. The apparatus may include means for determining a conditional block acknowledgment request or a block acknowledgment request associated with the one or more multicast data frames. The apparatus may include means for causing to send the one or more multicast data frames to at least one of the one or more multicast devices. The apparatus may include means for causing to send the conditional block acknowledgment request or the block acknowledgment request to the one or more multicast devices based at least in part on sent one or more multicast data frames.

Implementation may include one or more of the following features. The apparatus may further include means for identifying a block acknowledgment from at least one of the one or more multicast devices. The apparatus may further include means for identifying capability information associated with at least one of the one or more multicast devices. The apparatus may further include means for determining a buffer size of the at least one of the one or more multicast devices based at least in part on the capability information. The apparatus may further include means for determining that at least one of the one or more multicast data frames was not successfully received by the at least one of the one or more multicast devices. The apparatus may further include means for resending the at least one of the one or more multicast data frames to the at least one of the one or more multicast devices based at least in part on the block acknowledgment. The apparatus may further include means for sending a block acknowledgment request instead of the conditional block acknowledgment request after resending the at least one of the one or more multicast data frames. The apparatus may further include means for selecting a new Modulation and Coding Scheme (MCS) based at least in part on an estimate of data frame error rate using a current MCS. The apparatus may further include a transceiver configured to transmit and receive wireless signals.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A device, comprising:
at least one memory that stores computer-executable instructions; and
at least one processor of one or more processors configured to access the at least one memory, wherein the at least one processor is configured to execute the computer-executable instructions to:
determine a multicast session with one or more multicast devices;
determine one or more multicast data frames;
determine a conditional block acknowledgment request or a block acknowledgment request associated with the one or more multicast data frames;
cause to send the one or more multicast data frames to at least one of the one or more multicast devices; and
cause to send the conditional block acknowledgment request or the block acknowledgment request to the one or more multicast devices based at least in part on the sent one or more multicast data frames.

2. The device of claim 1, wherein the at least one processor is further configured to execute the computer-executable instructions to identify a block acknowledgment from at least one of the one or more multicast devices.

3. The device of claim 1, wherein the at least one processor is further configured to execute the computer-executable instructions to identify capability information associated with at least one of the one or more multicast devices.

4. The device of claim 3, wherein the at least one processor is further configured to execute the computer-executable instructions to determine a buffer size of the at least one of the one or more multicast devices based at least in part on the capability information.

5. The device of claim 3, wherein the at least one processor is further configured to execute the computer-executable instructions to determine that at least one of the one or more multicast data frames was not successfully received by the at least one of the one or more multicast devices.

6. The device of claim 5, wherein the at least one processor is further configured to execute the computer-executable instructions to resend the at least one of the one or more multicast data frames to the at least one of the one or more multicast devices based at least in part on the block acknowledgment.

7. The device of claim 6, wherein the at least one processor is further configured to execute the computer-executable instructions to cause to send a block acknowledgment request instead of the conditional block acknowledgment request after resending the at least one of the one or more multicast data frames.

8. The device of claim 1, wherein the at least one processor is further configured to execute the computer-executable instructions to select a new Modulation and Coding Scheme (MCS) based at least in part on an estimate of data frame error rate using a current MCS.

9. The device of claim 1, further comprising a transceiver configured to transmit and receive wireless signals.

10. The device of claim 9, further comprising an antenna coupled to the transceiver.

11. A non-transitory computer-readable medium storing computer-executable instructions which, when executed by a processor, cause the processor to perform operations comprising:
identifying one or more multicast data frames received from a first device;
identifying a conditional block acknowledgment request received from the first device;
determining one or more missing multicast data frames; and
causing to send a feedback frame to the first device based at least in part on one of the one or more missing multicast data frames.

12. The non-transitory computer-readable medium of claim 11, wherein the computer-executable instructions cause the processor to further perform operations comprising causing to send the feedback frame within a predetermined time window.

13. The non-transitory computer-readable medium of claim 12, wherein causing to send the feedback frame within the predetermined time window occurs after a backoff time.

14. The non-transitory computer-readable medium of claim 12, wherein the predetermined time window is associated with the conditional block acknowledgment request.

15. The non-transitory computer-readable medium of claim 11, wherein the computer-executable instructions cause the processor to further perform operations comprising identifying one or more retransmitted multicast data frames associated with the missing multicast data frames.

16. The non-transitory computer-readable medium of claim 11, wherein the computer-executable instructions cause the processor to further perform operations comprising determining capability information, including a buffer size associated with the one or more multicast data frames.

17. The non-transitory computer-readable medium of claim 16, wherein the computer-executable instructions cause the processor to further perform operations comprising causing to send the capability information to the first device.

18. A method comprising:
determining a multicast session with one or more multicast devices;
determining one or more multicast data frames;
determining a conditional block acknowledgment request or a block acknowledgment request associated with the one or more multicast data frames;
causing to send the one or more multicast data frames to at least one of the one or more multicast devices; and
causing to send the conditional block acknowledgment request or the block acknowledgment request to the one or more multicast devices based at least in part on sent one or more multicast data frames.

19. The method of claim 18, further including identifying a block acknowledgment from at least one of the one no more multicast devices.

20. The method of claim 18, further including determining that at least one of the one or more multicast data frames was not successfully received by the at least one of the one or more multicast devices.
